(19) United States
(12) Patent Application Publication
(10) Pub. No.: US 2007/0146147 A1
(43) Pub. Date: Jun. 28, 2007

(54) Optical/RF TV Device with Remote Fault Detection

(76) Inventor: Joseph M. Kocott, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(21) Appl. No.: 11/538,661

(22) Filed: Oct. 4, 2006

Related U.S. Application Data
(60) Provisional application No. 60/723,360, filed on Oct. 4, 2005.

(51) Int. Cl. G08B 17/00

(52) U.S. Cl. 340/585

(57) ABSTRACT

A power outage detection device that is configured to be easily coupled to Optical/Rf TV signal transmission devices having test contacts, wherein the power outage detection device of the present invention preferably includes a housing with viewable LED display lights on at least one surface thereof, and an extended coupling line extending from the housing, the coupling line including power connections for attachment to the appropriate test contacts of the subject line device; and a port coupler around the coupling line for attachment to a test port or open port of the in line device.

### RELATED APPLICATIONS

This application claims the benefit of U.S. Provisional patent application Ser. No. 60/723,360 entitled “Optical/RF TV Device with Remote Fault Detection” filed Oct. 4, 2005.

### BACKGROUND OF THE INVENTION

1. Field of the Invention

The present invention relates generally to optical or electrical signal transmission components with remote fault detection. More particularly, the present invention relates to simple economic fault detection components for existing optical/RF TV (e.g., Cable TV) signal transmission devices.

2. Background Information

Power transmission systems and telephone networks have both developed an extensive complement of network management and fault detection devices and techniques. The cable television industry, however, does not have simple devices applicable to the line components for fault detection and repair. Currently when a given line (which may serve up to 1000 customers) has been identified as having a problem (such as through customer service call or hub station report), the workers must manually check the individual line components (e.g. signal amplifiers, relays, and the like) on the suspect line to ascertain the particular problem.

The manual checking of line components requires the workers to access and test each sequential line component. In an aerial system (i.e. mounted on poles), the workers must climb the pole associated with each particular line component and check the subject line component till the line has been cleared and corrected (i.e. the faulty line components identified and repaired.

This manual line checking procedure is labor intensive and minimizes the life of the subject line components, because the existing testing requires the workers to interface with the device, attach test point thereto, and possibly open the subject device (where the test point is internal). The more that line components are opened, or even physically handled, the shorter the life span will be. Opening of the line components allows internal water migration, particularly in inclement weather associated with line outages.

In the line mounted optical/RV TV signal transmission devices there is a need for remote fault detection whereby standard device testing can be performed without physically accessing the device (i.e. not climbing the pole or opening the in-ground access, etc).

### SUMMARY OF THE INVENTION

The various embodiments and examples of the present invention as presented herein are understood to be illustrative of the present invention and not restrictive thereof and are non-limiting with respect to the scope of the invention.

According to one embodiment of the present invention addressing the above stated objects, the present invention provides a power outage detection (POD) device that can be easily coupled to Optical/Rf TV signal transmission devices. The POD device of the present invention preferably includes a housing with viewable LED display lights on at least one surface thereof an extended coupling line extending from the housing, the coupling line including power connections for attachment to the appropriate test contacts of the subject line device; and a port coupler around the coupling line for attachment to a test port or open port of the in line device. The housing is mounted to the subject in line device, or adjacent thereto, in a position that allows for maximum viewing (i.e. viewable from the road adjacent the pole). The visible LED display will provide for a remotely viewable status indicator for the particular device.

When using the present invention on all the relevant, active or passive, devices on a given line, a worker can merely drive by (assuming that the line is adjacent a roadway), visually inspect and diagnose the problem with any errant line device. The workers need not climb a pole, open a pedestal, or interface with the properly operating devices.

These and other advantages of the present invention will be clarified in the description of the preferred embodiments taken together with the attached figures.

### BRIEF DESCRIPTION OF THE DRAWINGS

FIG. 1 is a schematic side view of an aerial line optical/Rf TV signal transmission device with fault detection in accordance with the present invention;

FIG. 2 is a schematic perspective view of an pedestal housing at least one optical/Rf TV signal transmission device with fault detection in accordance with the present invention;

FIG. 3 is a perspective view of an in line fault detection device for attachment to an Optical/Rf TV signal transmission device in accordance with the present invention; and

FIG. 4 is a perspective view of an in line fault detection device for attachment to an Optical/Rf TV signal transmission device in accordance with the present invention.

### DESCRIPTION OF THE PREFERRED EMBODIMENTS

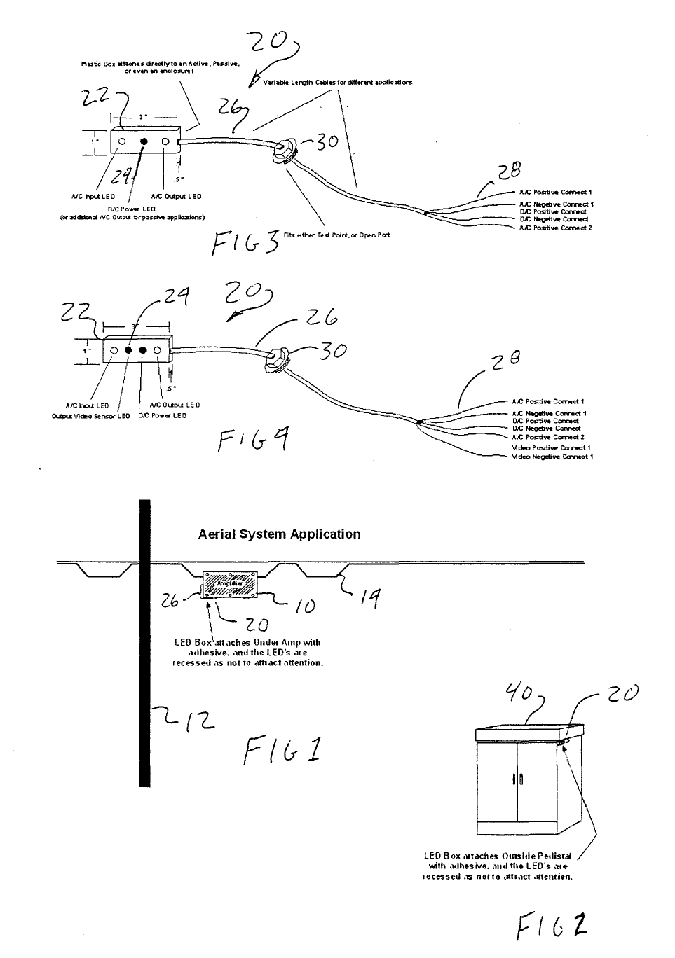

FIG. 1 is a schematic side view of an aerial line optical/Rf TV signal transmission device, specifically a signal amplifier 10, with fault detection in accordance with the present invention. The amplifier 10 is an aerial system mounted on poles 12 or other supports for the line 14, as known in the art.

The present invention provides a power outage detection (POD) device 20 shown in detail in FIGS. 3 and 4 that can be easily coupled to Optical/Rf TV signal transmission devices, such as 12. The POD device 20 of the present invention preferably includes a housing 22 with viewable LED display lights 24 on at least one surface thereof and an extended coupling line 26 extending from the housing 12. The coupling line 26 including power connections 28 for attachment to the appropriate test contacts of the subject line device, such as 12, and a port coupler 30 around the coupling line 26 for attachment to a test port or open port of the in line device, such as 12. The housing 12 is mounted to the subject in line device, or adjacent thereto, in a position that allows for maximum viewing (i.e. viewable from the road adjacent the pole). FIG. 2 illustrates the mounting of the device 20 on a pedestal 40 housing an associated device therein. The visible LED display formed by LED lights 24 will provide for a remotely viewable status indicator for the particular device.

The power outage detector device 20 of the invention as described above and illustrated in the figures provides the ability of users of the device 20 being able to drive by an active or passive device and to know if the device in question is operating properly, or to have the ability to visually diagnose what the problem is without having to climb a pole, open a pedestal or to even open the device in question. The POD device 20 will empower users to do that very thing. Reducing the number of poles climbed during a system outage will not only help in repairing the system outage faster, but it will also reduce the number of potential personnel injuries.

The utilization of the POD device 20 will improve the longevity of associated system equipment by reducing the need to open the subject device in question during bad weather conditions which would allow moisture to enter and be enclosed in the device. This will reduce future outages and system problems. Studies show that every time a system device is opened; the device in question has the potential of failure in the near future, if not immediately due to: Water ingress; Improper closing practices; and Physical damage to the device while open.

It will be apparent that the POD device may be provided in a number of configurations so that multiple applications may de implemented. The POD device 20 may have aerial device applications and underground device applications. The POD device 20 dimensions of a typical implementation are 3″L×1″ H×½″D with a variable length attachment cable. The POD device 20 cable will enter the active or passive device one of two ways: either through an available cable port, an occupied cable port via a connector extension, or by replacing a seizure screw cap. The POD device 20 may then be mounted, such as via adhesive, to the surface of the device or pedestal for optimal viewing conditions. Once the POD device cable has entered the device in question, the individual wires within the cable will be connected to the device test points, grounding screws, and fuse points.

Whereas particular embodiments of this invention have been described above for purposes of illustration and in the attached summary sheet, it will be evident to those skilled in the art that numerous variations of the details of the present invention may be made without departing from the invention.

What is claimed is:

1. A power outage detection device that is configured to be easily coupled to Optical/Rf TV signal transmission devices having test contacts, wherein the power outage detection device of the present invention preferably includes a housing with viewable LED display lights on at least one surface thereof, and an extended coupling line extending from the housing, the coupling line including power connections for attachment to the appropriate test contacts of the subject line device; and a port coupler around the coupling line for attachment to a test port or open port of the in line device.

2. The device of claim 1 wherein the housing is mounted to the subject in line device, whereby the visible LED display will provide for a remotely viewable status indicator for the particular device.
